(19) United States
(12) Patent Application Publication
(10) Pub. No.: US 2009/0085257 A1
(43) Pub. Date: Apr. 2, 2009

(54) Method for Producing Three-Dimensional Objects Using Segmental Prototyping

(75) Inventors: DONG YOL YANG, Daejeon (KR); SUK HEE PARK, Daejeon (KR)

Correspondence Address: BARDMESSER LAW GROUP, P.C., 1025 CONNECTICUT AVENUE, N.W., SUITE 1000, WASHINGTON, DC, 20006, US

(73) Assignee: KOREA ADVANCED INSTITUTE OF SCIENCE AND TECHNOLOGY, Daejeon (KR)

(21) Appl. No.: 12/239,746

(22) Filed: Sep. 27, 2008

(30) Foreign Application Priority Data
Sep. 28, 2007 (KR) 10-2007-0097873

(51) Int. Cl. B29C 35/04

(52) U.S. Cl. 264/401

(57) ABSTRACT

The method for manufacturing large three-dimensional objects of the present invention comprises the following steps: obtaining a three-dimensional shape data for a three-dimensional target object; converting the three-dimensional shape data into a size needed for manufacturing; transforming the size-converted data into a “shell” data (i.e., data of a hallow target object having a cavity therein); dividing the “shell” data into shell segments of such a size that can be manufactured by a rapid prototyping apparatus; prototyping each of the “shell” segments by a rapid prototyping apparatus to manufacture each of prototyped parts; assembling the prototyped parts to produce a prototype of the target three-dimensional shape object.

### CROSS-REFERENCE TO RELATED APPLICATIONS

This application claims priority to a Korean Patent Application No. 10-2007-0097873, filed on Sep. 28, 2007, incorporated by reference herein.

### BACKGROUND OF THE INVENTION

1. Field of the Invention

The present invention relates to a method for manufacturing large three-dimensional objects, and more particularly, to manufacturing large three-dimensional objects that exceed the size range of conventional rapid prototyping apparatus.

2. Description of the Related Art

A conventional method for rapid prototyping for manufacturing objects of a three-dimensional shape comprises the steps of spraying and applying liquid materials (such as radiation-cured resin) or powder-shaped materials (such as gypsum or starch components) on a platform of a rapid prototyping apparatus; radiation-curing the liquid or powdered materials; and then cooling or selective sintering the applied materials to obtain prototyped objects of a desired three-dimensional shape.

Yet another conventional method comprises the steps of cutting a sheet of flat-shaped material (such as paper or Styrofoam) with a laser or a hot wire based on a given data specifying a three-dimensionally shaped cross section, and connecting the obtained layers to each other in order to produce objects of a desired three-dimensional shape.

However, the conventional three-dimensional prototyping methods have significant drawbacks. For example, it is impossible to manufacture in the rapid prototyping apparatus objects of a shape which exceeds a size of a sheet of a material used. Furthermore, even when producing an object of a smaller size by conventional methods, a great deal of material is wasted, because at least some of the inner area of the shape is filled with the material.

A pending Korean Patent Application No. 2003-0071100 entitled “A Method for Manufacturing Large Objects by Using Reverse Design Technique” discloses a method of prototyping, whereby a three-dimensional shape of a reference object is scanned by using a three-dimensional scanning apparatus. The scanning apparatus converts a shape into a data set, and then the data set reflecting the three-dimensional shape of the reference object is enlarged and divided into segments.

This conventional method for manufacturing large objects proposes a technique whereby the entire three-dimensional shape data obtained by scanning the reference object is simply divided into data segments reflecting parts of the object, and these parts are prototyped separately. Then, a prototype is created by assembling the parts.

However, the above described method has a disadvantage in that the material is consumed excessively. Furthermore, manufacturing time can be very long due to the fact that the inner parts of the shape, which are not needed for assembling the desired shape, are also manufactured. Additionally, the conventional methods do not provide any means for assembling the solid parts of a desired shape that are manufactured separately. The solid parts might not be fit together well due to some errors in the position of bindings or joints between the parts.

Accordingly, there is a need in the art for a precise and efficient method for manufacturing large three-dimensional objects.

### BRIEF SUMMARY OF THE INVENTION

The present invention relates to a method for manufacturing large three-dimensional objects, and more particularly, to manufacturing large three-dimensional objects that exceed the size range that can be manufactured by a conventional rapid prototyping apparatus that substantially obviates one or more of the problems and disadvantages of the related art.

In one embodiment there is provided a method for manufacturing large three-dimensional objects whereby a three-dimensional shape data for the target object is obtained and converted into a size that can be manufactured by an ordinary rapid prototyping apparatus. The size-converted (i.e., reduced) data is made into a “shell” data for saving material. The “shell” data is a data of the same object without its inner content. In other words, the “shell” data is a data of a hollow three-dimensional object of the same shape as the original target object.

The “shell” data is divided into a plurality of “shell” segments (i.e., parts of the “shell” data) to be prototyped, and, then, a large object is assembled by using a joint structure or a binding provided in each of the “shell” segments. Thus, this makes it possible to manufacture a large three-dimensional object, which exceeds the production size range of a conventional rapid prototyping apparatus.

According to the exemplary embodiment, a variety of joining or binding elements are implemented in the joint portion of each part of the “shell’ data, so that it is possible to manufacture a large object, advantageously, using a well-fitting assembly between parts while reducing material consumption.

The proposed method for manufacturing large three-dimensional objects comprises the following steps: obtaining a three-dimensional shape data for a three-dimensional target object; converting the three-dimensional shape data into a size needed for manufacturing; transforming the size-converted data into a “shell” data (i.e., data of a hallow target object having a cavity therein); dividing the “shell” data into shell segments of such a size that can be manufactured by a rapid prototyping apparatus; prototyping each of the “shell” segments (i.e., parts of data) by a rapid prototyping apparatus to manufacture each of prototyped parts; and assembling the prototyped parts to produce a prototype of the target three-dimensional shape object.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates a flow chart of a segmental prototyping method in accordance with an exemplary embodiment;

FIG. 2 illustrates a schematic view depicting implementation of the segmental prototyping method in accordance with an exemplary embodiment;

FIGS. 3a and 3b illustrate a schematic view depicting creation of the joining elements formed on the “shell” segments in accordance with an exemplary embodiment;

FIG. 4 illustrates a schematic view depicting the cross sections of the various joining elements formed on the “shell” segments.

### DETAILED DESCRIPTION OF THE INVENTION

Reference will now be made in detail to the preferred embodiments of the present invention, examples of which are illustrated in the accompanying drawings.

A method for manufacturing large three-dimensional objects that exceed the size range of a conventional rapid prototyping apparatus is described. According to the exemplary embodiment, a three-dimensional shape data set for the target object is obtained and converted into a size that can be manufactured by an ordinary rapid prototyping apparatus. The size-converted (i.e., reduced) data is made into a “shell” data for saving material. The “shell” data is a data of the same object without its inner content. In other words, the “shell” data is data of a hollow three-dimensional object of the same shape as the original target object.

According to the preferred embodiment, the “shell” data is divided into a plurality of “shell” segments (i.e., parts of the “shell” data) to be prototyped, and, then, a large object is assembled by using a joint element or a binding provided in each segment of the “shell” data. Thus, a large three-dimensional object, which exceeds the size range of a conventional rapid prototyping apparatus, is produced.

A surface data of the size-converted data is offset inward by a required thickness to transform into the “shell” data of a hollow shape. Thus, the wall thickness of a resulting three-dimensional prototype is defined. The proposed method provides for forming a joining (or binding) elements on the appropriate surfaces of the “shell” segments data where the segments need to be attached to each other for the final assembly. In one embodiment the joining elements can be created in a form of a blade located along the contact surface (i.e., the surface where the “shell” segments contact each other).

In another exemplary embodiment, the joining elements can be formed in shape of a pin. The pins can be located at a given interval along the contact surface. Alternatively, the joining elements can be formed as a male-female coupling part also located at a given interval along the contact surface. The male coupling part can have wedge-shaped protuberances or a groove in the area that is in contact with the surface of the “shell” segment. The male coupling part and the female coupling part can be joined by liquid adhesives applied therebetween.

The outer diameter of an end portion of the male coupling part is made slightly larger than the inner diameter of the female coupling part, thus the parts can be joined firmly (rigidly) due to an elastic deformation. In addition, holes can be made on the contact surface, and connecting pins or bars, made of the same or a different material, can be inserted into these holes to join and fix the “shell” segments firmly.

Those skilled in the art will appreciate that the proposed method makes it possible to reduce unnecessary consumption of material that is particularly critical when manufacturing a large object. Also, the proposed method advantageously allows reducing the weight of the produced object by prototyping to a given thickness of the “shell” having the inner area of a three-dimensional object empty.

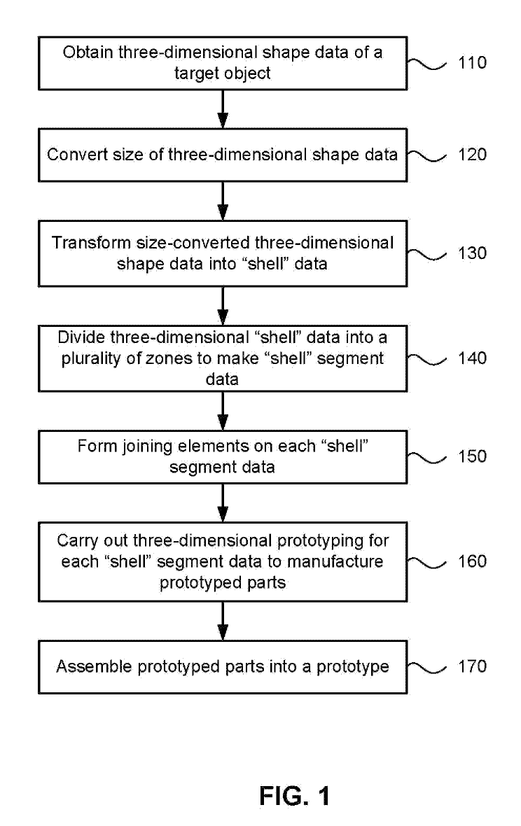

FIG. 1 illustrates a flow chart of a segmental prototyping method in accordance with an exemplary embodiment. A three-dimensional shape data of the three-dimensional large target object is obtained at step 110. Then, at step 120, the obtained data is converted to the data of the size necessary for final manufacturing of a prototype. The converted data is transformed into “shell” data at step 220. A process of transforming converted data into the “shell” data can include creating a shape of the inner surface by, for example, a method of offsetting inward by a specified thickness from a surface of the original outer surface contour.

It can also be done by a method of making simple reduction. The process of transforming into the “shell” data can be defined as a process of emptying the inside area of an object within a pre-determined range, while no distortion of outer shape occurs. This process should not compromise a mechanical strength and/or rigidity of a final shape assembly. Note that the shape of the inner area is not limited to a reduced shape of the outer shape. Alternatively, a space free of material inside the object (i.e., an empty space) can be of any shape or size.

Next, at step 140, the “shell” data is divided into a plurality of zones for making the “shell” data segments. Note that the “shell” data can be divided by an ordinary rapid prototyping apparatus. The size of a segment that can be made by a rapid prototyping apparatus is typically limited to tens of centimeters. Accordingly, the “shell” data is divided into segments of a manufacturing range in case when the “shell” data has a size exceeding the size that can be manufactured by a rapid prototyping apparatus.

Then, at step 150, the joining elements are formed on each of the “shell” segments produced at step 140. A three-dimensional prototyping of each “shell” segment is performed at step 160 and the prototyped parts are produced. The prototyped parts are assembled, at step 170, into a prototype of a target object.

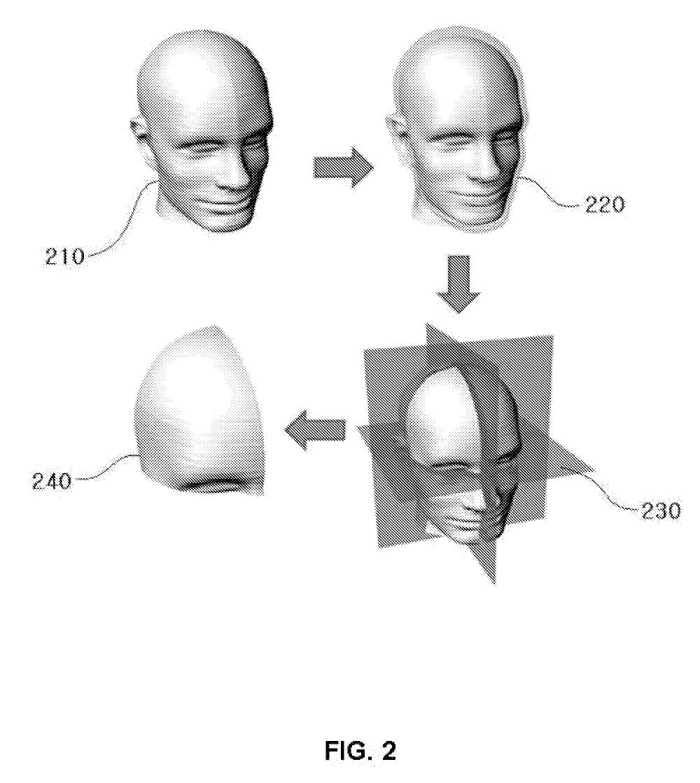

FIG. 2 illustrates a schematic view depicting implementation of the segmental prototyping method in accordance with an exemplary embodiment. A three-dimensional shape data 210 is obtained from a target object. The data 210 is size converted and transformed into a “shell” data 230. The “shell” data 230 is divided into “shell” segments 240.

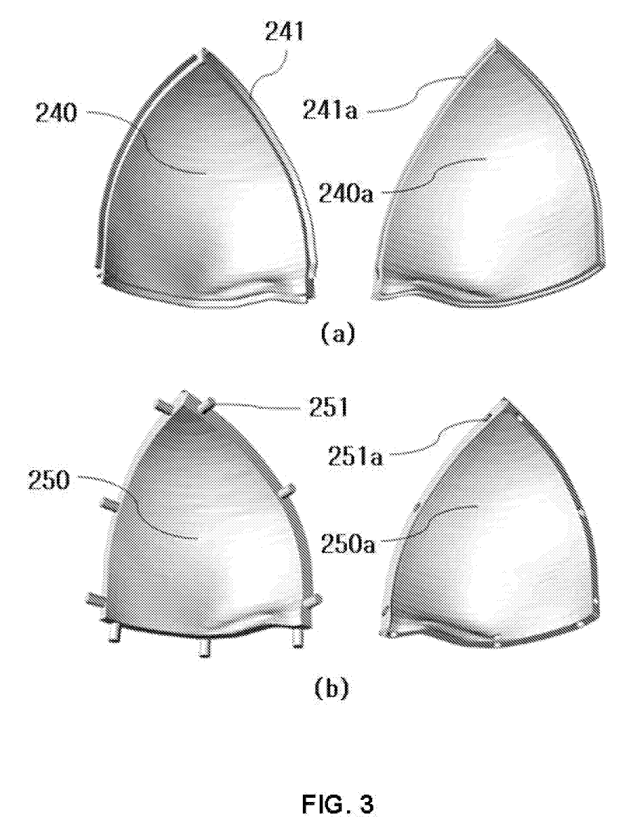

FIGS. 3a and 3b illustrate a schematic view depicting creation of the joining elements formed on the “shell” segments in accordance with an exemplary embodiment. FIG. 3a illustrates exemplary “shell” segments 240 and 240a than need to be joined together for a final assembly. The segment 240 has blade joining element 241 formed on its contact surface. The segment 240a has a groove joining element 241a. For a final assembly, the blade 241 is covered with an adhesive material and placed into the groove 241a. Thus, the segments 240 and 240a are firmly (rigidly) attached to each other. The same can be done for all segments used in the assembly.

FIG. 3a illustrates exemplary embodiment using pin type joining elements. The pins 251 are formed on the contact surface of a “shell” segment 250. The holes 251a are formed on the contact surface of the “shell” segment 250a. Thus, the segments 250 and 250a can be joined firmly using elastic deformation. Note that a number of pins in an array and the interval between pins can be selected based on desired joining strength and assembly efficiency.

After for the joining structures depicted in FIGS. 3a and 3b are formed, the segments 240, 240a, 250 and 250a are prototyped using a rapid prototyping apparatus. Then, a large three-dimensional object is manually assembled from the prototyped parts.

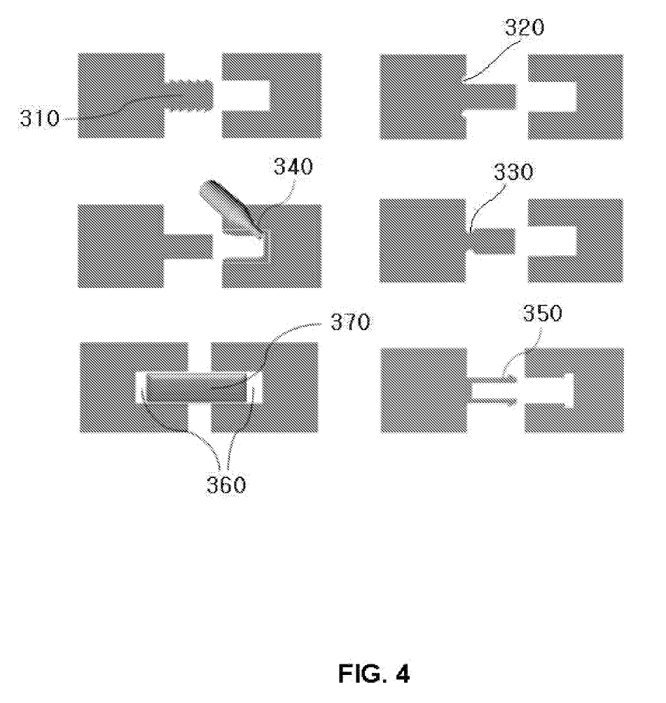

FIG. 4 illustrates a schematic view depicting the cross sections of the various joining elements formed on the “shell” segments in accordance with the exemplary embodiment. Grooves 320 and 330 with rounded edges can be formed on the contact area of a male coupling part (e.g., around the male coupling part that contacts the edge of the female coupling part formed on the “shell” segment data). Accordingly, deformation of the final shape that could occur due to the tolerance errors can be reduced during assembly.

The firm (rigid) assembly can be sufficiently maintained between the prototyped parts by using the grooves 320 and 330. Note that the grooves 320 and 330 can be formed not only in shapes having rounded edge cross sections, but also in various shapes of cross section, such as a square or a triangle.

Alternatively, wedge-shaped protuberances 310 can be formed on the male coupling element to maintain an even more rigid assembly. Liquid adhesive 340 can be applied in the gaps that occur due to the tolerance errors in the joining elements. In this case, hardened adhesives 340 provides for a firm assembly as well. An adhesive of a chemical reaction type, such as an epoxy resin, or an adhesive of a heat welding type, such as hot melting substance, can be used for providing a firm assembly of the segments.

Alternatively, a rigid assembly can be achieved by an elastic deformation without using adhesives 340. For example, if the outer diameter of the male coupling part 350 is formed slightly larger than the inner diameter of the female coupling part and the male coupling part is made capable of deforming, it is possible to achieve a firm joining of the segments by elastic deformation of the male coupling part 350.

Also, catch or traction protuberances can be formed at the tip of the male coupling element 350. In this case, the rigid binding can be provided by the catch grooves formed in the female coupling element. As yet another embodiment, holes 360 of a given size can be formed on the contact surfaces of both segments and a connecting bar 370 can be inserted and fixed into the holes 360 to provide for a firm binding. A thermoplastic adhesive can be used for fixating the bar 370 in the holes. Note that the connecting bar 370 can be melted by heating after it is inserted into the holes 360.

After the connecting joint element is cooled off, the melted connecting bar 370 is adhered and firmly fixated to the inside of the holes 360. In case when a solid adhesive is used as the connecting bar 370, it is preferable to use the material that is stronger than the material of the prototyped segments. Note that the joining elements that can be used in the exemplary embodiment for joining the segments are not limited to the ones depicted in FIG. 4, and can be of any type suitable for a rigid assembly. It also needs to be noted that various types of joining elements can be used in the same assembly. For example, some prototyped parts can be joined by an elastic deformation, while others can be connected by pins using an adhesive.

Those skilled in the art will appreciate that proposed method of segmental prototyping provides for manufacturing large objects exceeding the prototyping range of an ordinary rapid prototyping apparatus. According to the proposed method, the assembly can be made rigid by various joining elements implemented on the prototyped segments. Also, by adopting a segmental prototyping and assembly method, an efficient manufacturing is made possible and the production costs can be significantly reduced. For example, in case of a defective segment, only the defective segment needs to be reproduced. Then, this segment can be used in the assembly without the necessity to prototype the entire object again from the beginning.

Having thus described a preferred embodiment, it should be apparent to those skilled in the art that certain advantages of the described method and apparatus have been achieved. It should also be appreciated that various modifications, adaptations, and alternative embodiments thereof may be made within the scope and spirit of the present invention. The invention is further defined by the following claims.

What is claimed is:

1. A method for manufacturing three-dimensional objects comprising:
obtaining a three-dimensional shape data set for a three-dimensional target object;
converting the three-dimensional shape data set into a size needed for manufacture;
transforming the size-converted data set into a shell data set having a cavity therein;
dividing the shell data set into a plurality of shell segments, wherein each shell segment has a predetermined size;
prototyping each of the shell segments by a rapid prototyping apparatus, wherein the prototyping apparatus manufactures elements corresponding to the shell segments; and
assembling the elements to create a prototype of the three-dimensional target object.

2. The method of claim 1, wherein the transforming step further comprises offsetting a surface data of the size-converted data set inward by a predetermined thickness.

3. The method of claim 1, further comprising forming at least one joining element on a contact surface of each shell segment prior to prototyping the shell segments.

4. The method of claim 3, wherein the joining element is any of:
a blade and a grove joint;
a pin and a hole joint; and
a two holes and a connecting bar joint.

5. The method of claim 3, wherein the joining element comprises at least one male coupling part and at least one female coupling part.

6. The method of claim 5, wherein the male coupling part has a plurality of wedge-shaped protuberances.

7. The method of claim 5, wherein the male coupling part has a groove located at its base.

8. The method of claim 5, wherein the male coupling part and the female coupling part are joined by a liquid adhesive applied therebetween.

9. The method of claim 5, wherein an outer diameter of an end portion of the male coupling part is larger than an inner diameter of the female coupling part and the male coupling part is capable of deforming when inserted into the female coupling part.

10. The method of claim 9, wherein the male coupling part is joined with the female coupling part by elastic deformation.
